(19) United States
(12) Patent Application Publication
(10) Pub. No.: US 2005/0268587 A1
(43) Pub. Date: Dec. 8, 2005

(54) Robotic harvesting system

(76) Inventor: Colm McKeown, County Down (GB)

Correspondence Address: OSTROLENK FABER GERB & SOFFEN, 1180 AVENUE OF THE AMERICAS, NEW YORK, NY, 100368403, US

(21) Appl. No.: 10/523,725

(22) PCT Filed: Aug. 5, 2003
(86) PCT No.: PCT/GB03/03415

§ 371 Date: Feb. 4, 2005

(30) Foreign Application Priority Data
Aug. 5, 2002 (GB) 0218125.3

(51) Int. Cl. A01D 75/28

(52) U.S. Cl. 56/10.2 R

(57) ABSTRACT

A harvesting head (1, 21), a robotic harvesting system and a method of harvesting objects such as fruit or vegetables using the robotic harvesting system. Robotic harvesting systems for fruit or vegetables generate a percentage of damaged produce due to a lack of sensitivity and adaptability of the system. The current harvesting system incorporates a controller (84) in communication with a load cell (52) which is mounted on the harvesting head (1, 21) for monitoring forces applied to the fruit or vegetables by the harvesting head (1, 21) and controlling the movement and operation of the harvesting head (1, 21) during a picking cycle by a control program executing on the controller in response to the monitored forces.

The present invention relates to a robotic harvesting system including a harvesting head and a method of harvesting fruit and vegetables with the head.

Traditionally, the harvesting of fruit and vegetables has been carried out manually by seasonally employed workers. This process is costly for the employer and is also labour intensive requiring the workers to stand all day at the side of a conveyor belt picking the fruit and vegetables and placing them in storage containers. With the advent of pick and place robots, a lot of the manual labour associated with fruit and vegetable harvesting has disappeared. However, the pick and place robots damage a proportion of the products, which results in a lower yield and reduced profits for owners of fruit and vegetable farm.

It is an object of the present invention to obviate or mitigate the problem of damaged fruit and vegetables as a result of harvesting by pick and place robots.

Accordingly, the present invention provides a harvesting head mountable on a robotic arm arrangement of the type having a robot end effector mounting flange and a rotation means, the head having a rotatable shaft with two ends, one end of the shaft being adaptable for engagement with the rotation means mounted on the robotic arm arrangement, the other end having a holder fixed thereon for receiving an object to be harvested, the holder including means for releasably fixing the object relative to the holder wherein a load cell is disposed on the harvesting head for measuring the force being applied to the object during harvesting.

In one embodiment, the load cell is mounted intermediate the robotic arm arrangement and the harvesting head for measuring the force applied to the object by the robotic arm arrangement via the holder of the harvesting head during harvesting.

In a second embodiment, there is provided a harvesting head mountable on a robotic arm arrangement, the head comprising a rotation means having a rotatable shaft extending therefrom, a holder for receiving an object to be harvested fixed on an external end of the shaft, the holder having a means for releasably fixing the object relative to the holder, the head further comprising a load cell mounted on a part of the head which is fixed relative to the robotic arm arrangement during harvesting for measuring the force being applied to the object by the robotic arm arrangement via the harvesting head.

In both of the above embodiments and in another to be described, the rotation means has a drive unit such as a motor for rotating the shaft.

In both embodiments, a controller is in communication with the load cell for receiving values of force measured by the load cell during the harvesting operation. The controller, having a control program stored thereon, is also in communication with the drive unit of the rotation means, a robotic arm arrangement movement control device and the means for releasably fixing the object to the holder. The controller controls the operation of these components in response to the values of force received from the load cell in combination with a predetermined sequence of events stored in the control program. The activation of the subsequent event is dependent upon the successful completion of the current event.

In both embodiments, the harvesting head is mounted on a robotic arm arrangement of the type having a robot end effector-mounting flange.

Preferably, the robotic arm arrangement has an integral vision system capable of determining the geometrical location of an object to be harvested, the vision system including intelligent pattern recognition software. This software includes artificial intelligence using neutral network technology.

Ideally, the robotic arm arrangement has a movement control device for locating the harvesting head on or about an object in response to the geometrical location of the object being translated into movement of the robotic arm arrangement by the controller.

Preferably, the controller is a Kistler charge amplifier such as Como II S.

Ideally, the control program stored on the controller has tolerance bands corresponding to maximum and minimum values of force.

Preferably, when the maximum value of force is received from the load cell by the controller and is read by the control program, the controller generates a signal and transmits it to the robotic arm arrangement movement control device preventing further downward movement of the harvesting head. The maximum value of force corresponds to a situation where one object, such as a mushroom, is located directly on top of another mushroom. This built in upper tolerance band prevents damage to either mushroom.

Ideally, when the minimum value of force is received from the load cell for a second time in one downward movement of the harvesting head and is read by the control program on the controller, the controller generates a signal and transmits the signal to the drive unit of the rotation means and simultaneously generates and transmits a signal to the means for releasably fixing the object to the holder and to the movement control device preventing further downward movement. The minimum value of force is recorded for a second time when the main root of an object to be harvested is broken.

Ideally, the means for releasably fixing the object relative to the holder is a vacuum generated between the holder and the surface of the object to be harvested.

Preferably, a vacuum pump generates the vacuum.

Ideally, the holder has a stem having one end formed for mounting the holder on the shaft and the other end has an expanded head extending therefrom for receiving objects to be harvested, the holder having a central cavity along the entire length thereof.

Preferably, the holder is manufactured from resilient, deformable material such as natural or synthetic rubber.

Ideally, the head has a concertinaed bellows-like form.

Preferably, the means for releasably fixing the object relative to the holder comprises a vacuum drum having a substantially solid body with a vacuum chamber enclosed within the body and a cylindrical bore extending through the body via the chamber, the cylindrical bore being formed for receiving a shaft of the rotation means, the shaft extending through the cylindrical bore and having its own bore extending from the end upon which the holder is mounted to a point along the shaft which the vacuum chamber encloses, the vacuum drum having a second bore extending from the vacuum chamber through the body of the vacuum drum and outside the drum, the bore defining an aperture on the external surface of the drum for receiving a vacuum pipe.

Ideally, the vacuum drum remains stationary when the shaft rotates.

Preferably, a pair of sealing o-rings are provided on the cylindrical bore of the vacuum drum, one on either side of the vacuum chamber for contacting the curved surface of the shaft thereby creating a sealed area within the vacuum drum.

In the first embodiment, the shaft extends directly into the drive unit of a rotation means, such as a motor.

The present invention provides a third embodiment of harvesting head for mounting on a robotic arm arrangement comprising a first rotatable shaft extending from a rotation means, a second rotatable shaft parallel with and offset laterally from the first rotatable shaft and a mounting means for fixing the shafts relative to one another, the shafts being coupled by a coupling means, the second shaft having a holder fixed on one end thereof, the holder including means for releasably fixing an object relative to the holder wherein a load cell is disposed on the head for measuring the force being applied to the object during harvesting.

Preferably, the coupling means comprises a belt which winds around a drive wheel on the first shaft and a drive belt guide on the second shaft.

In this third embodiment, the mounting means is provided by a support plate.

In this third embodiment, the motor is mounted on one side of a support plate having an aperture, the shaft extending through the aperture in the plate and engaging the drive wheel on the other side of the support plate.

In this third embodiment, the drive belt is rotatably mounted on a guide bolt which is in turn mounted on the support plate.

In this third embodiment, the load cell is mounted on the guide bolt.

The present invention also provides a method of harvesting objects such as mushrooms comprising the steps of:—
identifying a mushroom to be harvested and delivering a harvesting head having a load cell onto the mushroom which is to be picked out of a growing bed;
controlling the harvesting head to pick the mushroom via a control program executing in response to force values received from the load cell.

The method further comprising:—
using a robotic arm arrangement's vision system and movement control device to locate the harvesting head onto the mushroom;
moving the robotic arm arrangement and holder downwards pressing the mushroom into soil;
monitoring downward force, which is applied to the mushroom by the robotic arm arrangement via the load cell and control program.

In response to the measured force value reaching a maximum value once or a minimum value twice in the one downward movement, these values being stored as tolerance bands in the control program of the controller, the controller simultaneously generating and transmitting a signal to the rotation means, the robotic arm arrangement's movement control device and the fixing means thereby simultaneously
(1) stopping the downward motion of the robotic arm arrangement;
(2) activating the means for releasably fixing the mushroom relative to the holder; and
(3) rotating the holder to break all roots holding the mushroom in the ground; after a predetermined period of time the controller generating a signal and transmitting the signal to the rotation means to switch off the rotation means;
   the controller generating and transmitting a signal to the robotic arm arrangement's movement control device to move the head to a predetermined position; and
the controller generating and transmitting a signal to the means for releasably fixing the mushroom relative to the holder turning off the fixing means whereby the mushroom drops into a receptacle.

The control program is configured so that the controller takes no action when the minimum force value is recorded for the first time during a downward motion of the harvesting head. This first time corresponds to a small force being reached when the harvesting head first contacts the mushroom. The minimum force value only activates the harvesting head to undertake the picking cycle when it is recorded for the second time in the one downward movement of the head. This corresponds to the roots of the mushroom breaking which results in a sudden fall in resistive force being applied to the load cell.

The present invention also provides a robotic harvesting system comprising a harvesting head having a load cell and a movement control device for delivering the harvesting head onto an object to be picked out of a growing bed, the system having a controller in communication with the load cell which controls a picking cycle in response to values received from the load cell.

Ideally, the robotic harvesting system comprises a harvesting head as claimed in any one of claims 1 to 7 or any one of claims 8 to 14 mounted on a robotic arm arrangement of the type having a robot end effector mounting flange.

Ideally, the controller is also in communication with a rotation means and a means for releasably fixing the object relative to the holder of the harvesting head.

Preferably, the operation of the rotation means, the means for releasably fixing the object relative to the holder and the robotic arm arrangement movement control device during the picking cycle are controlled by values of force received from the load cell in combination with a control program stored on the controller.

The present invention also provides a vacuum drum having a substantially solid body with a vacuum chamber enclosed within the body and a cylindrical bore extending through the body via the chamber, the cylindrical bore being formed for receiving a shaft of a rotation means, the shaft extending through the cylindrical bore and having its own bore extending from the end upon which a holder is mounted to a point along the shaft which the vacuum chamber encloses, the vacuum drum having a second bore extending from the vacuum chamber through the body of the vacuum drum and outside the drum, the bore defining an aperture on the external surface of the drum for receiving a vacuum pipe.

The present invention will now be described with reference to the accompanying drawings which shown by way of example only, two embodiments of a harvesting head in accordance with the invention.

In the drawings:—

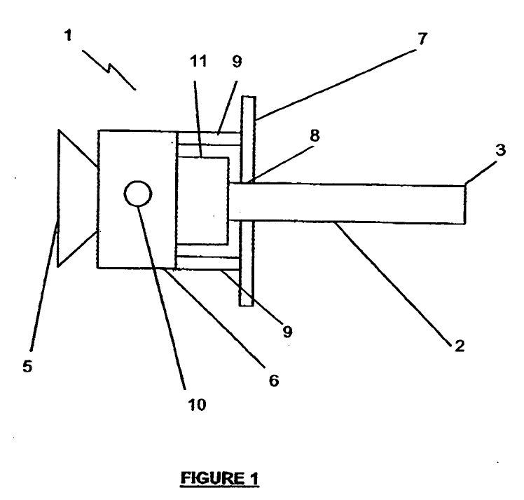

FIG. 1 is schematic view of a first embodiment of harvesting head;

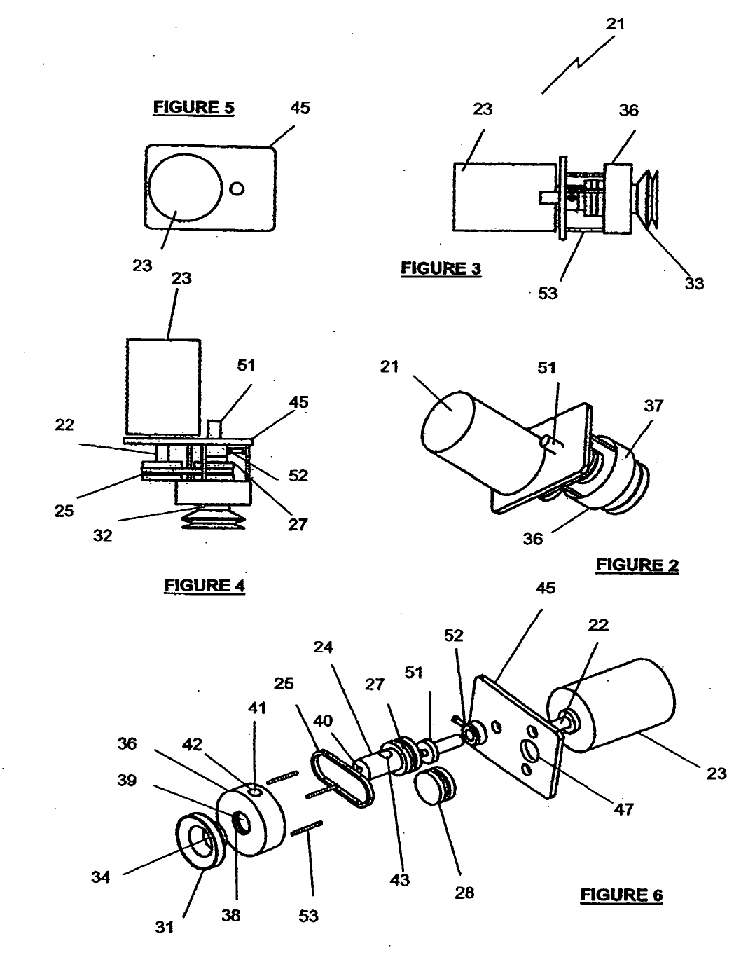

FIG. 2 is a perspective view of a third embodiment of harvesting head;

FIG. 3 is a plan view of FIG. 2;

FIG. 4 is a front elevation view of FIG. 2 and FIG. 3;

FIG. 5 is a side view of FIGS. 2 to 5;

FIG. 6 is an exploded view of FIGS. 2 to 5;

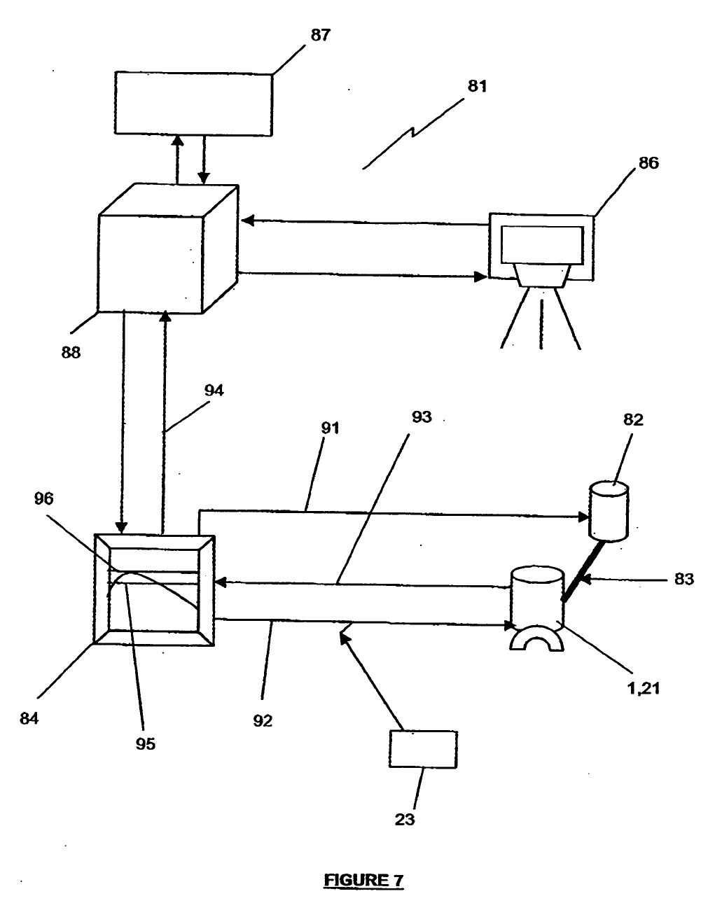

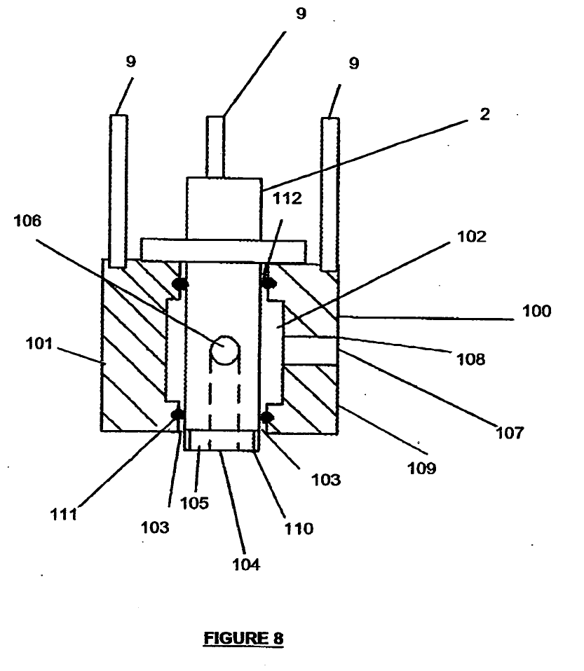

FIG. 7 is a schematic drawing of the harvesting system; and

FIG. 8 is a section view through a vacuum drum.

Referring to the drawings and initially to FIG. 1, there is shown a harvesting head indicated generally by the reference numeral 1. The head 1 comprises a rotatable shaft 2 with two ends 3 and 4. The end 3 is adapted to be connected directly to the drive unit of a motor (not shown) and the other end 4 carries a holder 5 thereon. The holder 5 is mounted on one end 4 of the rotatable shaft 2 and operable with a vacuum drum 6 releasably fixing an object (not shown) to the holder 5. The support plate 7 had a plurality of holes, one central hole 8 and three holes (not shown) spaced around the central hole 8. The shaft 2 extends through the central hole 8 and three parallel support rods 9 extend between the three holes (not shown) in the support plate 7 and the vacuum drum 6, the vacuum drum 6 having three holes (not shown) which align with and receive the parallel support rods 9. These rods 9 prevent rotation of the vacuum drum 6 during rotation of the shaft 2. The vacuum drum 6 has an aperture 10 formed for receiving a vacuum pipe (not shown). A collar 11 is provided for engagement with a shoulder (not shown) on the shaft 2 preventing the shaft 2 moving longitudinally beyond a predetermined position.

Referring to the drawings and now to FIG. 2 to FIG. 6, there is shown a third embodiment of harvesting head indicated generally by the reference numeral 21. The head 21 has a first rotatable shaft 22 extending from a motor 23. A second shaft 24 parallel with and offset laterally from the first shaft 22 is coupled to the first shaft 22 by a drive belt 25. The belt 25 winds around a drive belt guide 27 carried on one end of the second shaft 24 and a drive wheel 28 aligned with the drive belt guide 27, the drive wheel 28 being mounted on the free end of the first rotatable shaft 22. A holder 31 is shown having a stem 32 for mounting the holder 31 on the shaft 24. An expanded head 33 extends from the stem 32 and a central cavity 34 extends along the entire length of the holder 31. The head 33 has a concertinaed bellows like form and the stem 32 of the holder 31 is adjacent a vacuum drum 36. The vacuum drum 36 has a substantially solid body 37 with a vacuum chamber 38 enclosed within the body. A cylindrical bore 39, extending through the body 37 via the chamber 38, is formed for receiving the shaft 24. The shaft 24 has an internal bore 40 extending from the end of the shaft 24 carrying the holder 31 to a point on the curved surface of the shaft 24 defining an aperture 43 enclosed by the vacuum chamber 38. The vacuum drum 36 has a second bore 41 extending between the vacuum chamber 38 and the area outside the vacuum drum 36. An aperture 42 is defined by the bore 41 on the external curved surface of the vacuum drum 36 and is formed for receiving a vacuum pipe (not shown) which is in turn connected to a vacuum pump 82 (FIG. 7).

The motor 23 is mounted on one side of a support plate 45 having an aperture 47 with the first shaft 22 extending through the aperture 47 in the plate 45. The drive belt guide 27 is mounted on a guide bolt 51 which in turn is mounted on the support plate 45. A load cell 52 is mounted on the guide bolt 51. The load cell of this embodiment is suitable to be mounted on all embodiments of the invention. Three support pins 53 connect the vacuum drum 36 to the support plate 45.

Referring to the drawings and now to FIG. 7, the schematic drawing shows the harvesting head 1, 21, incorporated into a harvesting system indicated generally by the reference number 81. The vacuum drum 6, 36 (see FIGS. 2 to 6) of the head 1, 21, is connected to a vacuum pump 82 by a vacuum line 83. A controller 84, such as a Kistler charge amplifier Como II S, is in communication with the vacuum pump 82 via a channel 91, with the load cell 52 via a channel 93 and with a robotic arm arrangement movement control device 88 via a channel 94. A vision system 86 for the robotic arm arrangement is in communication with the robotic arm arrangement's movement control device 88 and with intelligent pattern recognition software 87.

Referring finally to FIG. 8, a vacuum drum 100 has a solid body 101 with a vacuum chamber 102 enclosed within the body 101. A cylindrical bore 103 extends through the body 101 via the chamber 102. The shaft 2 extends through the cylindrical bore 103 and the shaft 2 has an internal bore 104 extending from the end 105 of the shaft 2 upon which a holder 5, 31 (see FIGS. 1 to 6) is mounted to a point 106 along the shaft 2 enclosed by the vacuum chamber 102. The vacuum drum 100 has a second bore 107 extending from the vacuum chamber 102 through the body 101 to the area outside the drum 100. The bore 107 defines an aperture 108 on the external surface 109 of the drum 100 for receiving a vacuum pipe 83 (see FIG. 7). The end 105 of the shaft 2 for receiving the holder has a threaded portion 110 for securely mounting the holder thereon. A portion of the bore 107 for receiving the vacuum pipe is also threaded for securely mounting the vacuum pipe 83 thereon. A pair of sealing O-rings 111, 112 are provided on the cylindrical bore 103, one ring 111,112 on each side of the vacuum chamber 102 for contacting the shaft 2 creating a sealed area within the chamber 102. Three support rods 9 are mounted on the vacuum drum 100 and the support plate 7 (see FIG. 1) preventing rotation of the drum 100.

In use, the pattern recognition software 87 determines which mushroom to pick after receiving visual information from the robot vision system 86 which scans the mushroom beds. The robotic arm arrangement's movement control device 88 receives the geometrical location of the mushroom from the software 87 and guides the harvesting head 1, 21, to the selected mushroom. The harvesting head 1, 21 is located adjacent to the mushroom and a force value is received from the load cell indicating that the harvesting head 1, 21 is accurately located. At this point control of the harvesting head 1, 21 is no longer carried out by the positional information received by the vision system 86. Instead, the picking cycle of the harvesting head 1, 21 is now controlled by force values received by the load cell 52 in combination with a control program running on a controller 84 including tolerance bands 95, 96 contained thereon. The controller 84 signals the robotic arm arrangement's movement control device 88 to move the harvesting head 1, 21 downwards. Downward force is measured by the load cell 52 and when sufficient force is applied, the mushroom's roots break resulting in a sharp drop in force. This drop of force results in the controller 84 recording a second break in the lower tolerance band 95 (value set by test) which sends a signal and a vacuum is generated between the holder 5, 31 and the mushroom by the controller 84 turning on the vacuum pump 82. A signal is simultaneously sent to a relay which turns on the motor 23 for rotational movement of the holder 5, 31. This breaks the remaining roots. Simultaneously, a signal is sent to the robotic arm arrangement's movement control device 88 to stop downward movement and after a pre-determined time (0.5-1 sec), a signal is sent to the relay to stop the motor 23. A signal is then transmitted from the controller 84 to the robotic arm arrangement's movement control device 88 and the robotic arm arrangement delivers the mushroom to the finishing operation. The robotic arm arrangement can do this or a secondary system can take over.

The vacuum pump 82 is turned off and the mushroom drops into a receptacle provided such as a package or secondary system (not shown).

There is an upper tolerance band 96 set in the controller 84, which corresponds to a force value, again set by testing, occurring when a mushroom is on top of another mushroom. The downward force should not damage either mushroom and if the upper tolerance band 96 is broken downward force is removed and twist movement is initiated to remove the top mushroom. After the mushrooms within the robotic arm arrangement's working envelope have been harvested either the robotic arm arrangement moves on a gantry or a conveyor moves area to the next segment. This continues constantly and for best performance of the system a constant flow (stop-start) on a conveyor/gantry would be optimal use of the equipment.

Variations and modifications can be made without departing from the scope of the invention described above and as defined in the appended claims.

1. A harvesting head mountable on a robotic arm arrangement of the type having a robot end effector mounting flange and a rotation means, the head having a rotatable shaft with two ends, one end of the shaft being adaptable for engagement with the rotation means and the other end having a holder fixed thereon for receiving an object to be harvested, the holder including means for releasably fixing the object relative to the holder wherein a load cell is disposed on the harvesting head for measuring the force being applied to the object during harvesting.

2. A harvesting head as claimed in claim 1, wherein the rotatable shaft extends from the rotation means.

3. A harvesting head as claimed in claim 1, wherein the load cell is mounted on a part of the harvesting head which is fixed relative to the robotic arm arrangement during harvesting.

4. A harvesting head as claimed in claim 1, wherein the holder has a stem having one end formed for mounting the holder on the shaft and the other end has an expandable head extending therefrom for receiving objects to be harvested, the holder having a central cavity extending along the entire length of the holder.

5. A harvesting head as claimed in claim 1 wherein the means for releasably fixing an object relative to the holder comprises a vacuum drum having a substantially solid body with a vacuum chamber enclosed within the body and a cylindrical bore extending through the body via the chamber, the cylindrical bore being mounted on the shaft which extends therethrough, the shaft also having a bore extending from the end upon which the holder is mounted to a point along the shaft which the vacuum chamber encloses, the vacuum drum having a second bore extending from the vacuum chamber through the body of the vacuum drum and outside the drum, the bore defining an aperture on the external surface of the drum for receiving a vacuum pipe.

6. A harvesting head as claimed in claim 5, wherein the vacuum drum is stationary during rotation of the shaft.

7. A harvesting head as claimed in claim 2, wherein the rotation means is a motor.

8. A harvesting head mountable on a robotic arm arrangement of the type having a robot end effector mounting flange wherein the harvesting head comprises a first rotatable shaft extending from a rotation means, a second rotatable shaft parallel with and offset laterally from the first rotatable shaft and a mounting means for fixing the shafts relative to one another, the shafts being coupled by a coupling means, the second shaft having a holder fixed on one end thereof, the holder including means for releasably fixing an object relative to the holder, wherein a load cell is disposed on the head for measuring the force being applied to the object during harvesting.

9. A harvesting head as claimed in claim 8, wherein the coupling means comprises a belt which winds around a drive wheel on the first shaft and a drive belt guide on the second shaft.

10. A harvesting head as claimed in claim 8, wherein the mounting means is provided by a support plate.

11. A harvesting head as claimed in claim 8, wherein the rotation means is a motor.

12. A harvesting head as claimed in claim 10, wherein the support plate has an aperture and the first rotatable shaft extends through the aperture in the plate, engaging the drive wheel on the other side of the support plate.

13. A harvesting head as claimed in claim 9, wherein the drive belt guide is rotatably mounted on a guide bolt which is in turn mounted on the support plate on the same side of the plate as the drive wheel.

14. A harvesting head as claimed in claim 13, wherein the load cell is mounted on the guide bolt.

15. A robotic harvesting system comprising a harvesting head having a load cell, the system having a movement control device for delivering the harvesting head onto an object to be picked out of a growing bed, the system also having a controller in communication with the load cell which controls a picking cycle in response to values received from the load cell.

16. A robotic harvesting system as claimed in claim 15, wherein the harvesting head is mountable on a robotic arm arrangement of the type having a robot end effector mounting flange wherein the harvesting head comprises a first rotatable shaft extending from a rotation means, a second rotatable shaft parallel with and offset laterally from the first rotatable shaft and a mounting means for fixing the shafts relative to one another, the shafts being coupled by a coupling means, the second shaft having a holder fixed on one end thereof, the holder including means for releasably fixing an object relative to the holder, wherein a load cell is disposed on the head for measuring the force being applied to the object during harvesting and a harvesting head is mounted on a robotic arm arrangement of the type having a robot end effector mounting flange.

17. A robotic harvesting system as claimed in claim 15, wherein the controller is also in communication with a rotation means and a means for releasably fixing the object relative to the holder of the harvesting head.

18. A robotic harvesting system as claimed in claim 17, wherein the operation of the rotation means, the means for releasably fixing the object relative to the holder and the robotic arm arrangement movement control device during the picking cycle are controlled by values of force received from the load cell in combination with a control program running on the controller.

19. A method of harvesting objects such as mushrooms comprising the steps of:—identifying a mushroom to be harvested and delivering a harvesting head having a load cell onto the mushroom which is to be picked out of a bed; controlling the harvesting head to pick the mushroom via a control program executing in response to force values received from the load cell.

20. A method of harvesting objects such as mushrooms as claimed in claim 19 comprising the steps of:—
identifying a mushroom to be harvested and locating a holder adjacent the selected mushroom using a robotic arm arrangement's vision system and movement control device;
moving a robotic arm arrangement and holder downwards pressing the mushroom into the soil;
monitoring downward force, which is applied to the mushroom by the robotic arm arrangement via the load cell and control program;
in response to the measured force value reaching a maximum value once or a minimum value twice in the one downward movement, these values being stored as tolerance bands in the control program of the controller, the controller simultaneously generating and transmitting a signal to the rotation means, the robotic arm arrangement's movement control device and the fixing means thereby
(1) stopping the downward motion of the robotic arm arrangement;
(2) activating a means for releasably fixing the mushroom relative to the holder; and
(3) rotating the holder to break all roots holding the mushroom in the ground;
after a predetermined period of time the controller generating a signal and transmitting the signal to the rotation means to switch off the rotation means; the controller generating and transmitting a signal to the robotic arm arrangement's movement control device to move the head to a predetermined position; and the controller generating and transmitting a signal to the means for releasably fixing the mushroom relative to the holder turning off the fixing means whereby the mushroom drops into a receptacle.

21. A robotic harvesting system as claimed in claim 15, wherein the harvesting head is mountable on a robotic arm arrangement of the type having a robot end effector mounting flange and a rotation means, the head having a rotatable shaft with two ends, one end of the shaft being adaptable for engagement with the rotation means and the other end having a holder fixed thereon for receiving an object to be harvested, the holder including means for releasably fixing the object relative to the holder wherein a load cell is disposed on the harvesting head for measuring the force being applied to the object during harvesting and a harvesting head is mounted on a robotic arm arrangement of the type having a robot end effector mounting flange.
